(19) United States
(12) Patent Application Publication
(10) Pub. No.: US 2022/0414596 A1
(43) Pub. Date: Dec. 29, 2022

(54) METHOD AND SYSTEM FOR AUTOMATICALLY ROUTING ONE OR MORE SHIPMENTS IN A SUPPLY CHAIN NETWORK

(71) Applicant: Flipkart Internet Private Limited, Bengaluru (IN)

(72) Inventor: Abhinav GROVER, Hauz Khas (IN)

(73) Assignee: Flipkart Internet Private Limited, Bengaluru (IN)

(21) Appl. No.: 17/807,942

(22) Filed: Jun. 21, 2022

(30) Foreign Application Priority Data
Jun. 23, 2021 (IN) 202141028203

(51) Int. Cl. G06Q 10/08

(52) U.S. Cl. CPC G06Q 10/08355

(57) ABSTRACT

The present disclosure provides a method [200] and system [100] for automatically routing one or more shipments in a supply chain network. The method encompasses providing, by a ciphertext generator unit [102], a scannable ciphertext associated with information for one or more assets in the supply chain network. The method further encompasses detecting, by a detection unit [104], at least one event based on a change in one or more parameters. The method thereafter leads to dynamically updating, by a processing unit [106], the information associated with the scannable ciphertext based on detection of the at least one event. Further the method encompasses automatically routing, by the processing unit [106], the one or more shipments in the supply chain network based on the updated information associated with the scannable ciphertext.

### TECHNICAL FIELD

The present disclosure generally relates to the field of supply chain network, and more particularly, to systems and methods for automatically routing one or more shipments in a supply chain network.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

A supply chain is a system between a customer and a supplier to supply a specific product to the customer. The supply chain starts with a delivery of the specified product from the supplier and ends with the delivery of the specific product to the customer. The supply chain involves a series of steps to deliver the specific product to the customer. The entities involved in the supply chain are customers, suppliers, transportation companies, and distribution centers. The entities of the supply chain include all the functions that start with receiving an order to meet the customer's request.

In the current supply chain network, once the shipment has left from source to destination, the path of shipment is fixed. Quite often, after the shipment has left from one location/entity in the supply, there occurs unforeseen changes in the next entities that are about receive the shipment during its course through the supply chain. However, because of the fixed shipment path, the existing solutions can't change the remaining route of the shipment. Due to this deadlock, the shipment does not reach the customer on time and there are delays in delivery of shipments to the customer.

Therefore, the existing technologies have provided various solutions for routing one or more shipments in a supply chain network, but these currently known solutions have many limitations and therefore, there is a need for improvement in this area of technology.

### SUMMARY

This section is provided to introduce certain aspects of the present disclosure in a simplified form that are further described below in the detailed description. This summary is not intended to identify the key features or the scope of the claimed subject matter.

An aspect of the disclosure relates to a method for automatically routing one or more shipments in a supply chain network. The method encompasses providing, by a ciphertext generator unit, a scannable ciphertext associated with information for one or more assets in the supply chain network. The method further encompasses detecting, by a detection unit, at least one event based on a change in one or more parameters. The method thereafter leads to dynamically updating, by a processing unit, the information associated with the scannable ciphertext based on detection of the at least one event. Further the method encompasses automatically routing, by the processing unit, the one or more shipments in the supply chain network based on the updated information associated with the scannable ciphertext.

Another aspect of the disclosure relates to a system for automatically routing one or more shipments in a supply chain network. The system comprises a ciphertext generator unit configured to provide a scannable ciphertext associated with information for one or more assets in the supply chain network. The system further comprises a detection unit, configured to detect at least one event based on a change in one or more parameters. Further, a processing unit configured to dynamically update the information associated with the scannable ciphertext based on detection of the at least one event, and automatically route the one or more shipments in the supply chain network based on the updated information associated with the scannable ciphertext.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure.

FIG. 1 illustrates an exemplary block diagram of a system [100] for automatically routing one or more shipments in a supply chain network, in accordance with exemplary embodiments of the present disclosure.

FIG. 2 illustrates an exemplary method flow diagram depicting a method [200] for automatically routing one or more shipments in a supply chain network, in accordance with exemplary embodiments of the present disclosure.

The foregoing shall be more apparent from the following more detailed description of the embodiments of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As disclosed in the background section the existing technologies have many limitations. In the current supply chain network, once the shipment has left from source to destination, the path of shipment is fixed. The shipment usually has a bar code for every asset, the barcode being associated with static information. For example, there is an order placed where the item is in Delhi and the customer is in Bangalore. Then, the supply chain network determines the initial path i.e. Delhi to Bangalore via Jaipur and Mumbai. Whenever hub in Delhi scans, it knows it needs to place shipment for truck going to Jaipur. Similarly Jaipur hub knows it has to send the shipment to Mumbai and Mumbai knows it has to send the shipment to Bangalore.

Now due to external events such as Covid or floods in Mumbai, Mumbai hub may be closed. Unfortunately, Jaipur hub keeps on sending the shipment to the same hub in Mumbai which can't process those shipments as the hub is choked which leads to delays in shipment delivery for customers. This is a very common problem and leads to delays in delivery of shipments.

In order to overcome at least some of the limitations of the prior known solutions, the present disclosure provides a solution for automatically routing one or more shipments in a supply chain network. By automatically routing the one or more shipments in the supply chain network based on the updated information associated with the scannable ciphertext, the present disclosure provides a solution to the technical problem of delays in delivery of shipments.

The present disclosure introduces a method and system for automatically routing one or more shipments in a supply chain network. The present solution improves the processing speed of the shipments and reduces delay of shipment delivery by automatically routing the one or more shipments in the supply chain network based on the updated information associated with the scannable ciphertext.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a smartphone” and the like may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a user, a processing unit, a storage unit, a display unit, an identification unit, a transceiver unit and/or any other such unit(s) which are capable of implementing the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least a data that may be required by one or more units of the system/user device to perform their respective functions.

The present disclosure is further explained in detail below with reference now to the diagrams.

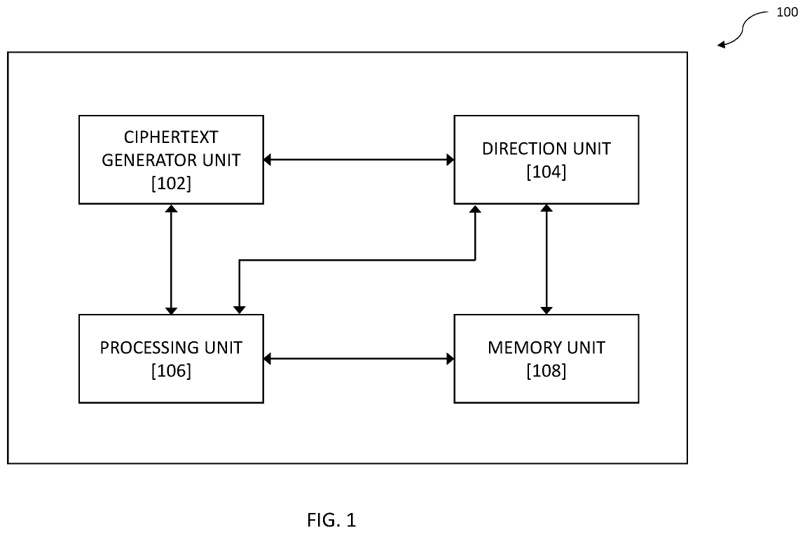

Referring to FIG. 1, an exemplary block diagram of a system [100] for automatically routing one or more shipments in a supply chain network is shown. In an implementation the system [100] may be connected to a supply chain network and in another implementation the system [100] may resides within the supply chain network to implement the features of the present disclosure.

The system [100] comprises at least one ciphertext generator unit [102], at least one detection unit [104], at least one processing unit [106], and at least one memory unit [108]. All of these components/units are assumed to be connected to each other unless otherwise indicated below. Also, in FIG. 1 only few units are shown, however, the system [100] may comprise multiple such units or the system [100] may comprise any such number of the units as required to implement the features of the present disclosure.

The system [100] is configured to automatically route one or more shipments in a supply chain network, with the help of the interconnection between its components/units.

The ciphertext generator unit [102] of the system [100] is connected to the at least one detection unit [104], the at least one processing unit [106], and the at least one memory unit [108]. The ciphertext generator unit [102] is configured to provide a scannable ciphertext associated with information for one or more assets in the supply chain network. The scannable ciphertext may be a bar code, a QR code, or any other scannable code as may be obvious to a person skilled in the art. The ciphertext comprises a unique private key for each asset of the one or more assets in the supply chain network, and a routing information of the one or more shipments. The unique private key for each asset is generated based on a deniable encryption technology to provide unique information for each asset corresponding to the private keys of each asset.

As used herein, ‘assets’ are one or more delivery partners who aid in achieving the delivery of a shipment from a source location to a destination location. For instance, assets may include first mile assets, mother hubs or primary processing centers, secondary processing centers, delivery hubs, etc. First mile assets aggregate and pick up the shipments from sellers, sort the shipments and send them to mother hubs. The mother hubs or primary processing centers process the shipments to transport it to secondary processing centers via different modes of transport such as air or surface (rail or road) or water. The secondary processing centers sort the shipment into last mile hubs handover to third party logistic providers/partners/delivery hubs. These delivery hubs receive the load and send the shipments to the customers. In the prior known solutions, every asset would use labels/barcodes pasted on the shipments for finding out the path using which the shipment is to be transferred from one asset to another. Typically, in the prior art, one barcode is pasted on the shipment for each asset. Such codes when scanned provide the routing information of the shipment. In the present solution however, a single ciphertext is provided on the shipment, such that when it is scanned by any asset, the information relevant to that particular asset is shown to the asset.

Further, the information associated with the ciphertext, for each asset may include different information. For instance, the information for first mile assets may include tracking ID, merchant reference ID of the merchant from whom the shipment is to be collected, route to be followed to forward the shipment to the secondary hub, etc. Similarly, in another example, the information for the last mile hubs or delivery hubs may also include customer address, customer phone number, route to be followed, etc.

The detection unit [104] of the system [100] is connected to the at least one ciphertext generator unit [102] and the at least one processing unit [106]. The detection unit [104] is configured to detect at least one event based on a change in one or more parameters associated with the one or more assets in the supply chain. The one or more parameters comprises a weather condition, an asset processing speed, an asset operational status, a traffic condition, and one or more restrictions. As used herein, ‘event’ refers to any incident or occurrence based on a change in one or more parameters. For example, there is an order placed where the item is in Delhi and the customer is in Bangalore. Then, the supply chain network determines the initial path for shipment i.e. Delhi to Bangalore via Jaipur and Mumbai. Further, the supply chain network detects whether the Jaipur and Mumbai hubs are closed or opened due to external events such as covid or floods in Mumbai and Jaipur. If any of these hubs are closed due to floods in that location, the detection unit [104] detects such an event based on a change in the ‘weather’ parameter of the hub locations.

Further, the processing unit [106] is configured to dynamically update the information associated with the scannable ciphertext based on detection of the at least one event, and automatically route the one or more shipments in the supply chain network based on the updated information associated with the scannable ciphertext.

Also, the processing unit [106] is further configured to dynamically update the routing information of the one or more shipments. For example, there is an order placed where the item is in Delhi and the customer is in Bangalore. Then, the supply chain network determines the initial path for shipment i.e. Delhi to Bangalore via Jaipur and Mumbai. Further, when the supply chain network detects that the Jaipur and Mumbai hubs are closed due to external events such as covid or floods. So, based on this detection, the supply chain network updates the path for the shipment and routes the shipment to Indore rather than Mumbai and Jaipur.

Furthermore, the memory unit [108] is configured to store all the routing information of the one or more shipments. The memory unit [108] is configured to store routing information of the one or more shipments in a dedicated storage location. The memory unit [108] is also configured to store the updated real time values of the one or more parameters, as well as the updated information associated with each scannable ciphertext.

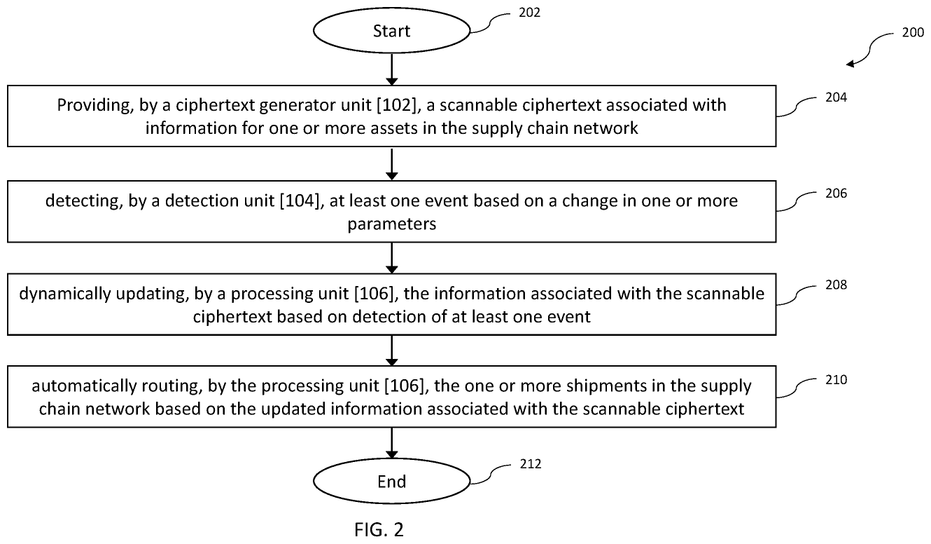

Referring to FIG. 2, an exemplary method flow diagram depicting a method [200] for automatically routing one or more shipments in a supply chain network, in accordance with exemplary embodiments of the present disclosure is shown. The method is performed by a system [100], wherein in an implementation the system is connected to a supply chain network and in another implementation the system [100] is placed in the supply chain network to implement the features of the present disclosure. As shown in FIG. 2, the method begins at step [202].

At step [204], the method comprises providing, by a ciphertext generator unit [102], a scannable ciphertext associated with information for one or more assets in the supply chain network. This ciphertext is placed on a shipment that is required to be moved through the supply chain. For instance, a QR code generated using deniable encryption technology may be pasted on a packet to be transferred from the merchant to the customer. The ciphertext comprises a unique private key for each asset of the one or more assets in the supply chain network, and a routing information of the one or more shipments. Further, the unique private key for each asset is generated based on a deniable encryption technology to provide unique information for each asset corresponding to the private keys of each asset. For instance, the same ciphertext, when scanned by one asset may provide some information, and when scanned by another asset may provide different information.

Next, at step [206], the method comprises detecting, by a detection unit [104], at least one event based on a change in one or more parameters. The one or more parameters comprises a weather condition, an asset processing speed, an asset operational status, a traffic condition, and one or more restrictions. For example, there is an order placed where the item is in Delhi and the customer is in Bangalore. Then, the supply chain network determines the initial path for shipment i.e. Delhi to Bangalore via Jaipur and Mumbai. Further, the supply chain network detects whether the Jaipur and Mumbai hubs are closed or opened due to external events such as covid or floods in Mumbai and Jaipur.

In an instance implementation, the step of detecting at least one event is based on a continuous monitoring of the one or more parameters. For instance, the weather condition of a delivery hub or a secondary hub is continuously monitored by the system [100] and the detection of an event occurs based on a change in the weather parameter.

In another instance implementation, the step of detecting at least one event is based on scanning of the ciphertext provided in the previous step by one or more assets. For instance, when the shipment with the ciphertext is sent from the first mile hub to the primary hub, and the ciphertext is scanned at the primary hub, a request for information is sent to the system [100] to retrieve the information associated with the ciphertext for that particular asset (i.e. primary hub). When such a request is received, the event is detected based on a change in the one or more parameters associated with the one or more assets.

Next, at step [208], the method comprises dynamically updating, by a processing unit [106], the information associated with the scannable ciphertext based on detection of the at least one event. Once an event is detected, for instance floods in a particular primary hub, then the information associated with the scannable ciphertext is updated for the first mile hub, so that the first mile hub now sends the shipment to a different primary hub and not to the hub that is affected by floods.

Thereafter, at step [210], the method comprises automatically routing, by the processing unit [106], the one or more shipments in the supply chain network based on the updated information associated with the scannable ciphertext. For example, there is an order placed where the item is in Delhi and the customer is in Bangalore. Then, the supply chain network determines the initial path for shipment i.e. Delhi to Bangalore via Jaipur and Mumbai. Further, when the supply chain network detects that the Jaipur and Mumbai hubs are closed due to external events such as covid or floods. So, based on this detection, the supply chain network updates the path for the shipment and routes the shipment to Indore rather than Mumbai and Jaipur.

The method further terminates at step [212].

As evident from the above disclosure, the present solution provides significant technical advancement over the existing solutions by automatically routing the one or more shipments in the supply chain network based on the updated information associated with the scannable ciphertext. Also, the solution provided by the present disclosure improves the processing speed of shipments and reduces the delay time of shipment. The invention encompasses that whenever a ciphertext is scanned, updated information associated with the ciphertext is sent in real time to the assets that scan the ciphertext. With the present solution, factors such as next assets real time processing speed, real time operational status, real time weather conditions of the assets, real time restrictions such as entry/exit timing of shipment trucks in a location, etc. can be taken into account before providing the routing information to an asset. Even after the shipment has left from one particular asset in the supply chain, the routing information of the shipment for the next assets can dynamically be updated with the implementation of the present invention.

While considerable emphasis has been placed herein on the disclosed embodiments, it will be appreciated that many embodiments can be made and that many changes can be made to the embodiments without departing from the principles of the present disclosure. These and other changes in the embodiments of the present disclosure will be apparent to those skilled in the art, whereby it is to be understood that the foregoing descriptive matter to be implemented is illustrative and non-limiting.

1. A method for automatically routing one or more shipments in a supply chain network, the method comprising:
providing, by a ciphertext generator unit [102], a scannable ciphertext associated with information for one or more assets in the supply chain network;
detecting, by a detection unit [104], at least one event based on a change in one or more parameters;
dynamically updating, by a processing unit [106], the information associated with the scannable ciphertext based on detection of the at least one event; and
automatically routing, by the processing unit [106], the one or more shipments in the supply chain network based on the updated information associated with the scannable ciphertext.

2. The method as claimed in claim 1, wherein the ciphertext comprises a unique private key for each asset of the one or more assets in the supply chain network, and a routing information of the one or more shipments.

3. The method as claimed in claim 2, wherein dynamically updating, by the processing unit [106], the information associated with the scannable ciphertext based on detection of the at least one event includes dynamically updating the routing information of the one or more shipments.

4. The method as claimed in claim 1, wherein detecting, by the detection unit, at least one event based on the change in one or more parameters further comprises dynamically and continuously monitoring, by the detection unit [104], the one or more parameters.

5. The method as claimed in claim 1, wherein the one or more parameters comprises a weather condition, an asset processing speed, an asset operational status, a traffic condition, and one or more restrictions.

6. The method as claimed in claim 2, wherein the unique private key for each asset is generated based on a deniable encryption technology to provide unique information for each asset corresponding to the private keys of each asset.

7. A system [100] for automatically routing one or more shipments in a supply chain network, the system [100] comprising:
a ciphertext generator unit [102] configured to provide a scannable ciphertext associated with information for one or more assets in the supply chain network;
a detection unit [104] connected to the ciphertext generator unit [102], the detection unit [104] configured to detect at least one event based on a change in one or more parameters;
a processing unit [106] connected to the ciphertext generator unit [102] and the detection unit [104], the processing unit [106] is configured to dynamically update the information associated with the scannable ciphertext based on detection of the at least one event, and automatically route the one or more shipments in the supply chain network based on the updated information associated with the scannable ciphertext.

8. The system [100] as claimed in claim 7, wherein the ciphertext comprises a unique private key for each asset of the one or more assets in the supply chain network, and a routing information of the one or more shipments.

9. The system [100] as claimed in claim 8, wherein the processing unit [106] is further configured to dynamically update the routing information of the one or more shipments.

10. The system [100] as claimed in claim 7, wherein the detection unit [104] is further configured to dynamically and continuously monitor the one or more parameters.

11. The system [100] as claimed in claim 7, wherein the one or more parameters comprises a weather condition, an asset processing speed, an asset operational status, a traffic condition, and one or more restrictions.

12. The system [100] as claimed in claim 8, wherein the unique private key for each asset is generated based on a deniable encryption technology to provide unique information for each asset corresponding to the private keys of each asset.
